(19) United States
(12) Patent Application Publication
(10) Pub. No.: US 2020/0087898 A1
(43) Pub. Date: Mar. 19, 2020

(54) System and Method For Conserving and Reusing Water in a Dwelling

(71) Applicant: Yuri Spiro, Beverly Hills, CA (US)

(72) Inventor: Yuri Spiro, Beverly Hills, CA (US)

(21) Appl. No.: 16/571,898

(22) Filed: Sep. 16, 2019

Related U.S. Application Data
(60) Provisional application No. 62/732,231, filed on Sep. 17, 2018.

(51) Int. Cl. E03B 11/02; C02F 1/00; E03B 1/04

(52) U.S. Cl. CPC E03B 11/02; C02F 1/001; E03B 2001/045; C02F 2307/14; E03B 1/041

(57) ABSTRACT

A system and method that facilitates water storage, conservation, use and subsequent recycling and re-use in a residential or commercial dwelling is provided. Water savings and rationing is enabled as the system will be configured to permit the efficient storage, use, and re-use of a fixed amount of water delivered to the dwelling. The system and method also anticipates and provides for semi-independence from a municipality or other government authority water source

### RELATED APPLICATIONS

This application claims the benefit of priority under 35 U.S.C. § 119(e) of Provisional Application No. 62/732,231 filed on Sep. 17, 2018. The provisional application is incorporated by reference herein in its entirety

### BACKGROUND OF THE INVENTION

### 1. Field of the Invention

The present invention relates to water distribution systems in residential and commercial, industrial dwellings and, more particularly, to a space saving and efficient plumbing system that economically distributes, stores and recycles water for use and re-use in the dwelling with minimal ecological impact.

### 2. Description of the Prior Art

Currently, plumbing systems in dwellings are designed around a central water storage and distribution means that relies on and anticipates a continuous supply of water from a water source. Specifically, a dwelling's plumbing system is connected to a municipal water service that under common current schemes, provides a steady supply of water to the dwelling, The water supplied to the dwelling is typically directed through a heating tank or element, where some of may be stored, and routed through the plumbing to the various faucet locations within the dwelling for use on demand by the inhabitants. Any water not fully consumed through such use is then drained by means of additional plumbing away from the dwelling. Such effluence is free to pollute streams and rivers, etc. This system consists of various inefficiencies and potential ecological damage. First, the decentralized nature of the plumbing system usually can result in a waste of water. This is particularly evident when a user is waiting for heated water to arrive at the faucet, shower or other point of use. Further, typical residential plumbing systems are not designed for situations where the water source, i.e., a municipality, implements a water rationing system to the residence or otherwise delivers only a fixed amount of water for use, and re-use when practical, by the residence for a set period of time. It is anticipated that municipalities and other water providing agencies will seek to encourage users to become more independent from the water source. It would desirable for such agencies to mandate a fixed amount of water usage. Moreover, current water storage solutions, such as a residence's hot water tank, are poorly designed in that they typically take up a n inordinate amount of space within the dwelling or from a point of view of the efficient use of space within the dwelling. There is also currently a desire for municipalities to reduce the burden on facilities for draining and removing waste water to rivers lakes and oceans. Associated ecological burdens are also a concern.

What is needed therefore is a system and method for providing water to a residence to be distributed for use in the residence in an efficient manner using a storage and filtration system that maximizes use, filtration and re-use of a fixed amount of water delivered to the residence while permitting full use by users, maintaining a minimal footprint within the dwelling, and having a minimal ecological impact.

### SUMMARY OF THE INVENTION

An exemplary embodiment of the invention includes a plumbing system of a dwelling comprising a series of water storage towers situated within a dwelling, each with heating systems and each configured to distribute water to faucets located near their respective locations. Also included is a reclamation tower designed to filter and purify unused drain water and reprocess that water to the storage towers for re-use.

### BRIEF DESCRIPTION OF THE DRAWINGS

FIG. 1 is a partial perspective view of an exemplary embodiment of the system of the invention.

### DETAILED DESCRIPTION OF THE INVENTION

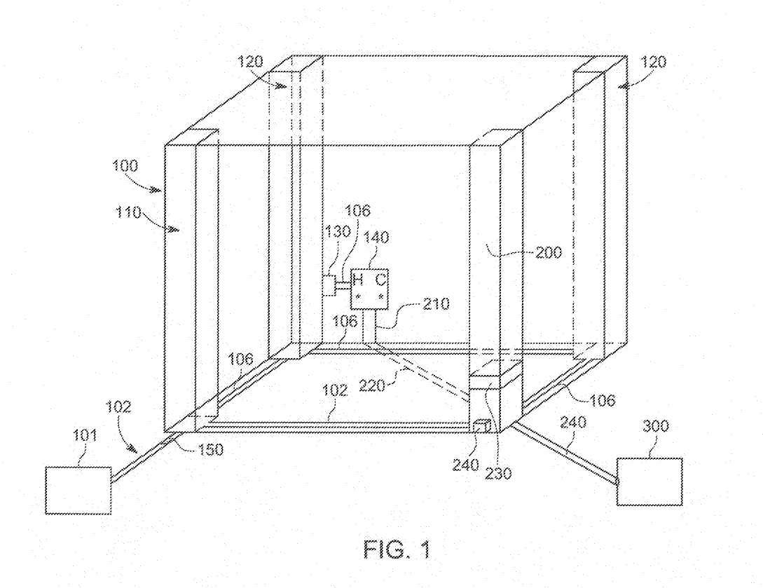

A preferred embodiment of the present invention provides a system for storing and using water in a dwelling with limited restrictions. Referring to FIG. 1, a schematic of the system is displayed. A dwelling (100) receives a supply of water from a typical utility water supply means (101). The water supplied by the supply means (101) is initially distributed via traditional plumbing (102) to a First Storage Tower (110) for storage and distribution. In this embodiment shown, the first storage tower (110) is located at and integrated into the design of the support column of the dwelling (100). Such location and integration is done to provide an aesthetically pleasing and unobtrusive location within the dwelling (100) to maximize living space within the dwelling while maximizing the storage capacity of the storage tower (110). It is understood that if there are upper floors present in the dwelling (100), the storage tower will extend vertically to said upper floors to provide for waster distribution to faucets at that level.

Second and third water storage towers (120) are shown in the embodiment of FIG. 1 and are located and integrated within the other support columns (105) of the dwelling (100). The first storage tower (110) is connected via tower plumbing (103) to the second and third Storage towers (120). Each storage tower (110) and (120) is provided with an associated water heating means (130) of those typically found in the art. Each storage tower (110) and (120) is configured to distribute water via pipeline system plumbing (106) to a faucet located within that particular tower's vicinity. The traditional plumbing (106), therefore, will be configured, in a preferred embodiment, for efficient delivery of water from the tower (110) or (120) to the faucet (140).

Also, if hot water is demanded at the faucet (140), then the water heating means (130) associated with the water tower (110) or (120) in the vicinity of the faucet (140) will be activated, again, in accordance with traditional means currently found in the art, to provide the necessary heating for delivery of hot water to that faucet (140).

This system as described above and in other similar embodiments will be configured to accept and store water delivered to the dwelling (100) by a water supply means (101). The system also features a delivery shut-off means (150) that allows the user/owner of the dwelling (100) to shut off water supply from the water supply means (101). It is understood that the shut off means (150) can be electronically or pressure controlled to be automatically activated when water delivered to the dwelling fills the water storage towers (110) and (120) or when a desired fixed amount of water has been delivered. It is also anticipated that there be a maintained a constant supply to compensate losses due to leaks. Also, a separate filtration system for watering of garden and to replenish water lost due to flushing toilets.

This feature will be especially useful where a municipality or other water supply means (101) limits the amount of water to be delivered to a dwelling (100) or where the owner/user of a dwelling (100) seeks to have delivered to the dwelling (100) a fixed amount of water. By way of example, in a preferred embodiment of the system, the owner/user of the system allows for a delivery of water to the dwelling (100) in an amount that is allocated to the dwelling (100) (either by the owner of the dwelling or the municipality providing the water). That water is then stored in the water towers (110) and (120) for use by the occupants of the dwelling (100) and is delivered to said occupants from the appropriate water tower (110) or (120) to a faucet (140).

The system also includes a water recycling and reclamation means (230). Referring to FIG. 1, the water recycling means is contained within a recirculating tower (200). In a preferred embodiment, a recirculating tower (200) is configured and located in a similar fashion to the first water storage tower (110) and additional storage towers (120). Namely, the recirculating tower (200) will be configured, located and integrated at or as a support column of the dwelling (100) to ensure unobtrusiveness and aesthetics and to maximize living space within the dwelling (100) and, if desired to provide support for the dwelling.

As shown in FIG. 1, each faucet (140) within the dwelling (100) will be accompanied by a drain (210) which will be connected to the reprocessing tower (200) via traditional drain plumbing (220). Drain water, i.e., reclaimed water from sinks, baths and showers will thus be collected and stored in the recirculating tower (200) for further reprocessing and redelivery and reuse. The recirculating tower will contain the water reclamation means (230) that is used to treat and purify the drain water.

The water reclamation means (230) will be of the type typically found in the art and in a preferred embodiment will include pressurized filtration and other purifying means sufficient to purify the drain water for re-use in sinks, baths, and showers in the dwelling (100) to meet applicable sanitary and health code standards. The recirculating tower (200) will be further configured to deliver purified water from the water reclamation means (230) to the first storage tower (110). This may be done via traditional plumbing (102).

In a preferred embodiment, as shown in FIG. 1, the recirculating tower (200) will also have a disposal means (240) to dispose of water not suitably filtered or recycled for use to the sewer system (300). This disposal means will be facilitated via traditional plumbing connected to the sewer system (300).

A water testing means (240) is configured within the recirculating tower (200) to ensure that water leaving the water reclamation means (230) is sufficiently purified for delivery to the first storage tower (110) for re-use. The water testing means (240) will be of those typically found in the art. In a preferred embodiment, the recirculating tower (200) will be further configured to divert water not able to be purified for reuse for sinks, baths and showers to other uses, including, toilet systems present in the dwelling (100) and landscape irrigation systems of the dwelling. Such configuration of the recirculating tower (200) will be accomplished via traditional plumbing (102) with appropriate ball valves to control the flow of water.

It is understood that as the fixed amount of water initially delivered to the dwelling (100) is consumed, the delivery shut off means (150) can be opened to allow replenishment of water to the dwelling (100) and for storage in the first storage tower (110).

As may be appreciated by one skilled in the art, the present disclosure may be embodied by methods. Specifically, the disclosure provides a method for the storage, delivery, recycling, and re-storage of a fixed amount of water delivered to a dwelling. In a preferred method, a fixed amount of water is first supplied to a dwelling. It is stored in the dwelling in a series of connected water storage containers. It is then distributed from a storage container to a nearby sinks, tubs and faucets in the dwelling for use. Any drained water is then directed to an additional storage and recycling container within the dwelling. That water is filtered and cleaned and then such water is then reintroduced to the dwelling via re-distribution to the water storage containers. This method is accomplished such that a dwelling (100) may efficiently store a fixed amount of water for use and then any unused drain water is then reclaimed, filtered and restored in a method that permits the re-use of said fixed amount of water.

It will be apparent to those skilled in the art that various modifications and associated methods can be made in the disclosed embodiments of the disclosed system and associated methods without departing from the spirit or scope of the disclosure. Thus it is intended that the present disclosure covers modifications and variations of the embodiments disclosed above provided that the modifications and variations come within the scope of any claims and their equivalents.

1. A water conservation and distribution system for a dwelling comprising: at least one storage tower integrated with a first support column of the dwelling and configured to receive and store a supply of water from a water source; a first plumbing means configured to distribute water from the storage tower to faucets in the dwelling; at least one heating means configured to receive water from the storage tower through the first plumbing means for heating and further configured to deliver heated water to a faucet in the dwelling; a second plumbing means configured to transfer water expelled from faucets to at least one recycling tower with said recycling tower integrated into a second support column of the dwelling and comprising a water reclamation means and further comprising a delivery means to return recycled water to the storage tower for re-use.

2. The system of claim 1 wherein the water reclamation means comprises a filtration means.

3. The system of claim 1 wherein the heating means is contained within the storage tower.

4. The system of claim 1 wherein the water tower is further configured to receive a fixed amount of water from the water source at specified periods of time.

5. The system of claim 1 wherein the reclamation means further comprises a disposal means configured to drain waste water away from the dwelling.

6. The system of claim 1 wherein the reclamation means further comprises a testing means configured to determine if water leaving the reclamation means to the storage tower is suitable for re-use.

7. A method for storing, distributing and recycling water in a dwelling comprising the steps of receiving water from a water source connected to the dwelling; storing the water in a storage tower located within the dwelling; delivering the water to faucets located within the dwelling upon demand; collecting water drained after use into a recycling tower; treating the drained water stored in the recycling storage tower to ensure suitability for re-use; and delivering the drained water to the storage tower for re-use in the dwelling.
